(19) United States
(12) Patent Application Publication
(10) Pub. No.: US 2022/0198494 A1
(43) Pub. Date: Jun. 23, 2022

(54) METHOD AND SYSTEM FOR IDENTIFICATION OF CLUSTERS IN GEOGRAPHICAL REGION

(71) Applicant: Dtwelve Spaces Private Limited, New Delhi (IN)

(72) Inventors: Eshaan GUPTA, New Delhi (IN); Anindya DUTTA, Gurugram (IN); Sandeep DALMIA, Delhi (IN)

(73) Assignee: Dtwelve Spaces Private Limited, New Delhi (IN)

(21) Appl. No.: 17/125,882

(22) Filed: Dec. 17, 2020

(51) Int. Cl. G06Q 30/02; G06Q 50/14; G06Q 50/26; G06Q 10/10; G06Q 50/16; G06Q 50/20; G06Q 50/12; G06F 16/28; G06F 16/901; G06T 11/20

(52) U.S. Cl. CPC G06Q 30/0205; G06Q 50/14; G06Q 50/26; G06Q 10/105; G06Q 50/16; G06N 3/0454; G06Q 50/12; G06F 16/285; G06F 16/9024; G06T 11/206; G06Q 50/20

(57) ABSTRACT

The present disclosure provides a method for providing cost efficient probable accommodation facilities in each of one or more area clusters. The method includes a first step to receive a first set of data associated with a plurality of organizations at a cluster identification system. The method includes another step to fetch a second set of data associated with a plurality of competitors. The method includes yet another step to obtain a set of rules associated with a plurality of parameters. The method includes yet another step to perform analysis of the first set of data, the second set of data, and the set of rules in real-time to identify the one or more area clusters in the geographical region based on the analysis of the first set of data and the second set of data with facilitation of the set of rules in real-time.

### TECHNICAL FIELD

The present disclosure relates to the field of data management. More particularly, the present disclosure relates to a method and system for identification of clusters in a geographical region.

### INTRODUCTION

Hospitality industry has been on a rise since the last few years. In addition, hospitality industry business provides comfortable paid-lodging on a short-term basis to generate revenue. The person involved in the hospitality industry has to invest in properties globally. The global real estate market includes millions of properties available to manage and invest. However, the person involved in the hospitality industry has to visit the property personally or through a real-estate agent. Further, the real-estate agent provides information about the areas with available properties for sale or rent.

Furthermore, the person wants to know about the surroundings or the locality before investing hard-earned money in the properties. The person has to travel from one home to another and deal with real-estate agents to gather complete information about the surrounding or locality in which the person is planning to invest. However, the entire process is time consuming and cumbersome for the person.

### SUMMARY

In a first example, a computer-implemented method is provided. The computer-implemented method for providing cost efficient probable accommodation facilities in each of one or more area clusters. The method includes a first step of receiving a first set of data associated with a plurality of organizations. The method includes another step of fetching a second set of data associated with a plurality of competitors in real-time. In addition, the method includes yet another step of obtaining a set of rules associated with a plurality of parameters in real-time. Further, the method includes yet another step of analyzing the first set of data, the second set of data, and the set of rules in real-time using one or more hardware-run algorithms. Furthermore, the method includes yet another step of identifying the one or more area clusters in the geographical region based on the analysis of the first set of data and the second set of data with facilitation of the set of rules in real-time. Moreover, the method includes yet another step of displaying the one or more area clusters on a communication device associated with an administrator in real-time. The first set of data is received in real-time. Also, each of the plurality of organizations is situated in the geographical region. The first set of data is received from a plurality of data sources. The plurality of data sources includes at least one of an offline data source or an online data source. The plurality of competitors are entities that provide the accommodation facilities. The second set of data is fetched from the plurality of data sources. The plurality of parameters is associated with the geographical region. The plurality of parameters includes demand data of the plurality of organizations, real-time road conditions, real-time traffic conditions, commuting distance, commuting time, maximum size of each cluster of the one or more area clusters, food accessibility, transportation accessibility, population density of the geographical region, and covered area of the geographical region. The set of rules associated with the plurality of parameters is obtained from the communication device. The analysis of the first set of data, the second set of data, and the set of rules is performed for identifying the one or more area clusters in the geographical area. Further, each cluster of the one or more area clusters is a visual representation of a region marked in the geographical region. The displayed one or more area clusters provide the cost efficient probable accommodation facilities.

In an embodiment of the present disclosure, the first set of data includes name of the plurality of organizations, contact numbers of the plurality of organizations, electronic mail addresses of the plurality of organizations, demographic information of employees working in the plurality of organizations, home town of employees working in the plurality of organizations, regional cuisine of employees working in the plurality of organizations, professional information of employees working in the plurality of organizations, accommodation requirement of the employees working in the plurality of organizations, positional coordinates of the plurality of organizations, demographic information of the plurality of organizations, and population density of the plurality of organizations.

In an embodiment of the present disclosure, the second set of data includes demographic information of the plurality of competitors, number of the accommodation facilities provided by each of the plurality of competitors, population density of each accommodation facility of each of the plurality of competitors, operating cost of each accommodation facility of each of the plurality of competitors, capital expenditure of each accommodation facility of each of the plurality of competitors, accommodation price of each accommodation facility of each of the plurality of competitors, number of rooms in each accommodation facility of each of the plurality of competitors, tenant capacity of each accommodation facility of each of the plurality of competitors, geographical location of each accommodation facility of each of the plurality of competitors, and address of each accommodation facility of each of the plurality of competitors.

In an embodiment of the present disclosure, the plurality of data sources include third party databases, accommodation industry databases, real-estate databases, database containing information of the plurality of organizations, database containing information of the plurality of competitors, government official databases, geographical information databases, demographic survey data, market research data and publically available real estate data.

In an embodiment of the present disclosure, the plurality of organizations include corporations, government organizations, non-government organizations, cooperative organizations, and educational institutions.

In an embodiment of the present disclosure, the set of rules enables dynamic identification of the one or more area clusters in the geographical region based on the plurality of parameters. The commuting distance and commuting time are calculated with facilitation of calculation of centroid of each of the plurality of organization of the plurality of organizations.

In an embodiment of the present disclosure, the accommodation facilities include apartments, paying guest accommodations, hostels, dormitories, hotels, guest houses, homestays, and living quarters.

In an embodiment of the present disclosure, the cluster identification system performs re-clustering of the one or more identified area clusters in real-time. The re-clustering is dynamic and adaptive based on real-time change in the first set of data, the second set of data, or the set of rules. The re-clustering is performed for updating the one or more area clusters in the geographical region.

In an embodiment of the present disclosure, the cluster identification system creates a cluster plot for each of the one or more area clusters of the geographical region based on the plurality of parameters. The cluster plot is characterized in one or more forms. The one or more forms include bar graph, histogram, pictogram, pie graph, line graph, and, cartesian graph. The cluster plot is downloadable in one or more formats. The one or more formats include chart, joint photographic experts group, portable network graphics, portable document format, scalable vector graphics, and comma-separated values.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for providing cost efficient probable accommodation facilities in each of one or more area clusters. The method includes a first step of receiving a first set of data associated with a plurality of organizations. The method includes another step of fetching a second set of data associated with a plurality of competitors in real-time. In addition, the method includes yet another step of obtaining a set of rules associated with a plurality of parameters in real-time. Further, the method includes yet another step of analyzing the first set of data, the second set of data, and the set of rules in real-time using one or more hardware-run algorithms. Furthermore, the method includes yet another step of identifying the one or more area clusters in the geographical region based on the analysis of the first set of data and the second set of data with facilitation of the set of rules in real-time. Moreover, the method includes yet another step of displaying the one or more area clusters on a communication device associated with an administrator in real-time. The first set of data is received in real-time. Also, each of the plurality of organizations is situated in the geographical region. The first set of data is received from a plurality of data sources. The plurality of data sources includes at least one of an offline data source or an online data source. The plurality of competitors are entities that provide the accommodation facilities. The second set of data is fetched from the plurality of data sources. The plurality of parameters is associated with the geographical region. The plurality of parameters includes demand data of the plurality of organizations, real-time road conditions, real-time traffic conditions, commuting distance, commuting time, maximum size of each cluster of the one or more area clusters, food accessibility, transportation accessibility, population density of the geographical region, and covered area of the geographical region. The set of rules associated with the plurality of parameters is obtained from the communication device. The analysis of the first set of data, the second set of data, and the set of rules is performed for identifying the one or more area clusters in the geographical area. Further, each cluster of the one or more area clusters is a visual representation of a region marked in the geographical region. The displayed one or more area clusters provide the cost efficient probable accommodation facilities.

In a third example, a non-transitory computer-readable storage medium is provided. The non-transitory computer-readable storage medium encodes computer executable instructions that, when executed by at least one processor, performs a method for providing cost efficient probable accommodation facilities in each of one or more area clusters. The method includes a first step of receiving a first set of data associated with a plurality of organizations. The method includes another step of fetching a second set of data associated with a plurality of competitors in real-time. In addition, the method includes yet another step of obtaining a set of rules associated with a plurality of parameters in real-time. Further, the method includes yet another step of analyzing the first set of data, the second set of data, and the set of rules in real-time using one or more hardware-run algorithms. Furthermore, the method includes yet another step of identifying the one or more area clusters in the geographical region based on the analysis of the first set of data and the second set of data with facilitation of the set of rules in real-time. Moreover, the method includes yet another step of displaying the one or more area clusters on a communication device associated with an administrator in real-time. The first set of data is received in real-time. Also, each of the plurality of organizations is situated in the geographical region. The first set of data is received from a plurality of data sources. The plurality of data sources includes at least one of an offline data source or an online data source. The plurality of competitors are entities that provide the accommodation facilities. The second set of data is fetched from the plurality of data sources. The plurality of parameters is associated with the geographical region. The plurality of parameters includes demand data of the plurality of organizations, real-time road conditions, real-time traffic conditions, commuting distance, commuting time, maximum size of each cluster of the one or more area clusters, food accessibility, transportation accessibility, population density of the geographical region, and covered area of the geographical region. The set of rules associated with the plurality of parameters is obtained from the communication device. The analysis of the first set of data, the second set of data, and the set of rules is performed for identifying the one or more area clusters in the geographical area. Further, each cluster of the one or more area clusters is a visual representation of a region marked in the geographical region. The displayed one or more area clusters provide the cost efficient probable accommodation facilities.

### BRIEF DESCRIPTION OF THE FIGURES

Having thus described the invention in general terms, reference will now be made to the accompanying drawings, which are not necessarily drawn to scale, and wherein:

FIG. 1 illustrates a general overview of an interactive computing environment for identification of one or more area clusters in a geographical region, in accordance with various embodiments of the present disclosure;

FIG. 2 illustrates an exemplary overview of the one or more area clusters in the geographical region, in accordance with various embodiments of the present disclosure;

FIGS. 3A and 3B illustrate a flowchart of a method for identification of the one or more area clusters in a geographical region, in accordance with various embodiments of the present disclosure; and

FIG. 4 illustrates a block diagram of a communication device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure.

It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

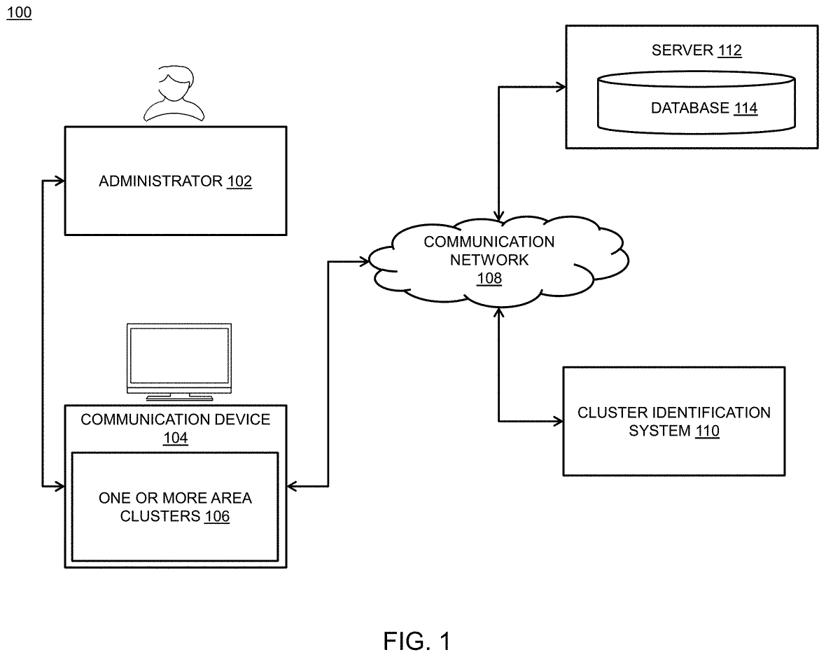

FIG. 1 illustrates a general overview of an interactive computing environment 100 for identifying one or more area clusters 106 in a geographical region, in accordance with various embodiments of the present disclosure. The interactive computing environment 100 includes an administrator 102, a communication device 104, the one or more area clusters 106, a communication network 108, and a cluster identification system 110. In addition, the interactive computing environment 100 includes a server 112 and a database 114.

The geographical region corresponds to any physical area (say land or water). In general, geographical region is an area of land that has natural or artificial features. In addition, geographical region is a physical region that supports habitation of human beings. In an example, geographical region includes an area, colony, sector, village, tehsil, city, state, town, country, continent, union territory, or combination thereof.

The interactive computing environment 100 includes the administrator 102. The administrator 102 is any person that is planning to lease new land or acquire already built properties to provide accommodation facilities to a plurality of tenants. In an embodiment of the present disclosure, the administrator 102 is a person that wants to identify potential locations to lease or rent the accommodation facilities to generate maximum revenue from the accommodation facilities. The accommodation facilities include apartments, paying guest accommodations, hostels, dormitories, hotels, guest houses, homestays, living quarters, and the like. In another embodiment of the present disclosure, the administrator 102 is a person that operates the cluster identification system 110. In yet another embodiment of the present disclosure, the administrator 102 is any person responsible for upkeep and maintenance of the cluster identification system 110. In yet another embodiment of the present disclosure, the administrator 102 is any person capable to troubleshoot the cluster identification system 110 in case of any error or bugs.

The interactive computing environment 100 includes the communication device 104. The communication device 104 is associated with the administrator 102. The communication device 104 is in switch on state. The administrator 102 utilizes the communication device 104 to operate the cluster identification system 110. In an embodiment of the present disclosure, the communication device 104 is any smart device that mainly comprises a display, camera and network connectivity. In an embodiment of the present disclosure, the communication device 104 is a portable communication device. In an example, the portable communication device includes laptop, smart phone, smart watch, tablet, PDA and the like. In another embodiment of the present disclosure, the communication device 104 is a fixed communication device. In an example, the fixed communication device includes a desktop, a workstation PC and the like.

The communication device 104 performs computing operations based on a suitable operating system installed inside the communication device 104. In general, operating system is system software that manages computer hardware and software resources and provides common services for computer programs. In addition, the operating system acts as an interface for software installed inside the communication device 104 to interact with hardware components of the communication device 104. In an embodiment of the present disclosure, the operating system installed inside the communication device 104 is a mobile operating system. In an embodiment of the present disclosure, the communication device 104 performs computing operations based on any suitable operating system designed for portable communication device. In an example, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry. However, the operating system is not limited to above mentioned operating systems. In an embodiment of the present disclosure, the communication device 104 operates on any version of particular operating system of above mentioned operating systems.

In another embodiment of the present disclosure, the communication device 104 performs computing operations based on any suitable operating system designed for fixed communication device. In an example, the operating system installed inside the communication device 104 is Windows from Microsoft. In another example, the operating system installed inside the communication device 104 is macOS from Apple. In yet another example, the operating system installed inside the communication device 104 is Linux based operating system. In yet another example, the operating system installed inside the communication device 104 may be one of UNIX, Kali Linux, and the like. However, the operating system is not limited to above mentioned operating systems.

In an embodiment of the present disclosure, the communication device 104 operates on any version of Windows operating system. In another embodiment of the present disclosure, the communication device 104 operates on any version of Mac operating system. In yet another embodiment of the present disclosure, the communication device 104 operates on any version of Linux operating system. In yet another embodiment of the present disclosure, the communication device 104 operates on any version of particular operating system of the above mentioned operating systems.

In an embodiment of the present disclosure, the communication device 104 includes an advanced vision display panel. The advanced vision display panel includes OLED, AMOLED, Super AMOLED, Retina display, Haptic touchscreen display and the like. In another embodiment of the present disclosure, the communication device 104 includes a basic display panel. The basic display panel includes but may not be limited to LCD, IPS-LCD, capacitive touchscreen LCD, resistive touchscreen LCD, TFT-LCD and the like.

The communication device 104 is connected to the communication network 108. The communication network 108 provides medium to the communication device 104 to connect to the cluster identification system 110. Also, the communication network 108 provides network connectivity to the communication device 104. In an example, the communication network 108 uses protocol to connect the communication device 104 to the cluster identification system 110. The communication network 108 connects the communication device 104 to the cluster identification system 110 using a plurality of methods. The plurality of methods used to provide network connectivity to the communication device 104 includes 2G, 3G, 4G, 5G, Wifi and the like.

In an embodiment of the present disclosure, the communication network 108 is any type of network that provides internet connectivity to the communication device 104. In an embodiment of the present disclosure, the communication network 108 is a wireless mobile network. In another embodiment of the present disclosure, the communication network 108 is a wired network with finite bandwidth. In yet another embodiment of the present disclosure, the communication network 108 is a combination of the wireless and the wired network for optimum throughput of data transmission. In yet another embodiment of the present disclosure, the communication network 108 is an optical fiber high bandwidth network that enables high data rate with negligible connection drops.

In an example, the communication network 108 includes but may not be limited to local area network, metropolitan area network, wide area network, and virtual private network. In an embodiment of the present disclosure, the communication device 104 is connected with the cluster identification system 110 using Local Area Network (LAN). In another embodiment of the present disclosure, the communication device 104 is connected with the cluster identification system 110 using Metropolitan Area Network (MAN). In yet another embodiment of the present disclosure, the communication device 104 is connected with the cluster identification system 110 using Wide Area Network (WAN).

The communication network 108 allows the administrator 102 to use the communication device 104 to connect with the cluster identification system 110. The cluster identification system 110 performs the method to identify the one or more area clusters 106 in the geographical region. In addition, each cluster of the one or more area clusters 106 is a visual representation of a region marked in the geographical region. The cluster identification system 110 identifies the one or more area clusters 106 to provide the cost efficient probable accommodation facilities in each of the one or more area clusters 106. In an embodiment of the present disclosure, the cluster identification system 110 is installed in the communication device 104. In another embodiment of the present disclosure, the cluster identification system 110 is accessed as web application in the communication device 104 of the administrator 102. In yet another embodiment of the present disclosure, the cluster identification system 110 is installed at the server 112. In yet another embodiment of the present disclosure, the cluster identification system 110 is accessed as mobile application in the communication device 104 of the administrator 102.

The cluster identification system 110 receives a first set of data associated with a plurality of organizations. The plurality of organizations includes corporations, government organizations, non-government organizations, cooperative organizations, and educational institutions. In general, corporation is a legal entity that is separate and distinct from its owners. In general, government organization is a permanent or semi-permanent organization in the machinery of government that is responsible for oversight and administration of specific functions (such as an intelligence agency). In general, non-government organization is an organization that is independent of any government. In general, cooperative organization is an autonomous association of persons united voluntarily to meet their common economic, social, and cultural needs and aspirations through a jointly-owned enterprise. In general, educational institution is a place where people of different ages gain education. In addition, educational institution provides a large variety of learning environments and learning spaces. In an example, educational institution includes preschool, childcare, primary-elementary schools, secondary-high schools, and universities.

The cluster identification system 110 receives the first set of data in real-time. In addition, each of the plurality of organizations is situated in the geographical region. The first set of data is received from a plurality of data sources. The plurality of data sources includes at least one of an offline data source or an online data source.

The first set of data includes name of the plurality of organizations, contact numbers of the plurality of organizations, electronic mail addresses of the plurality of organizations, and demographic information of employees working in the plurality of organizations. In addition, the first set of data includes home town of employees working in the plurality of organizations, regional cuisine of employees working in the plurality of organizations, and professional information of employees working in the plurality of organizations. Further, the first set of data includes accommodation requirement of the employees working in the plurality of organizations, positional coordinates of the plurality of organizations, demographic information of the plurality of organizations, and population density of the plurality of organizations. However, the first set of data is not limited to above mentioned data.

In an example, the first set of data includes name of all companies that are located in a particular region (say Gurugram). In addition, the first set of data includes address or geographical location of all companies that are located in Gurugram. In another example, the first set of data includes name of all colleges or institutions that are located in a particular region (say Noida). In addition, the first set of data includes address or geographical location of all colleges or institutions that are located in Noida. In yet another example, the first set of data includes information of number of employees working in an organization in Delhi. In yet another example, the first set of data includes information of home town of students studying in college XYZ in Ambala.

The cluster identification system 110 fetches a second set of data associated with a plurality of competitors in real-time. The plurality of competitors are entities that provide the accommodation facilities. The cluster identification system 110 fetches the second set of data from the plurality of data sources. The plurality of data sources includes third party databases, accommodation industry databases, real-estate databases, database containing information of the plurality of organizations, database containing information of the plurality of competitors, government official databases, geographical information databases, demographic survey data, market research data and publically available real estate data. However, the plurality of data sources is not limited to above mentioned data sources.

In an example, the second set of data includes information about all accommodation facilities of competitor A present in the geographical region (say Bengaluru). In another example, the second set of data includes information about all accommodation facilities of competitor B present in the geographical region (say Pune). In yet another example, the second set of data includes information about all accommodation facilities of competitor C present in the geographical region (say Hyderabad). In yet another embodiment of the present disclosure, the second set of data includes information about all accommodation facilities of competitor D present in the geographical region (say Mumbai).

The second set of data includes demographic information of the plurality of competitors, number of accommodation facilities provided by each of the plurality of competitors, and population density of each accommodation facility of each of the plurality of competitors. In addition, the second set of data includes operating cost of each accommodation facility of each of the plurality of competitors, capital expenditure of each accommodation facility of each of the plurality of competitors, and accommodation price of each accommodation facility of each of the plurality of competitors. Further, the second set of data includes number of rooms in each accommodation facility of each of the plurality of competitors, tenant capacity of each accommodation facility of each of the plurality of competitors, geographical location of each accommodation facility of each of the plurality of competitors, and address of each accommodation facility of each of the plurality of competitors. However, the second set of data is not limited to above mentioned data.

In an example, the second set of data includes data of geographical location and number of tenants staying in all accommodation facilities of competitor A in Noida. In another example, the second set of data includes data of geographical location and number of tenants staying in all accommodation facilities of competitor B in Delhi. In yet another example, the second set of data includes data of geographical location and number of tenants staying in all accommodation facilities of competitor C in Gurugram. In yet another example, the second set of data includes data of geographical location and number of tenants staying in all accommodation facilities of competitor D in Pune.

The cluster identification system 110 obtains a set of rules associated with a plurality of parameters in real-time. The plurality of parameters is associated with the geographical region. The plurality of parameters includes demand data of the plurality of organizations, real-time road conditions, real-time traffic conditions, commuting distance, commuting time, and maximum size of each cluster of the one or more area clusters 106. In addition, the plurality of parameters includes food accessibility, transportation accessibility, population density of the geographical region, and covered area of the geographical region. However, the plurality of parameters is not limited to above mentioned parameters. The set of rules associated with the plurality of parameters is obtained from the communication device 104 based on inputs from the administrator 102. In an embodiment of the present disclosure, the set of rules is obtained from the plurality of data sources.

In an embodiment of the present disclosure, demand data of the plurality of organization includes data of number of employees working in the plurality of organizations. In an embodiment of the present disclosure, real-time road conditions include national highways, u-turn, one way, road closures, sharp turns and the like. In an embodiment of the present disclosure, real-time traffic conditions include data of traffic jams, one way, narrow roads, and the like. In an embodiment of the present disclosure, commuting time and commuting distance are fetched from third party applications (say Google Maps, Here Maps, Apple Maps and the like).

In an embodiment of the present disclosure, the cluster identification system 110 determines the maximum size of each of the one or more area clusters 106. In another embodiment of the present disclosure, the administrator 102 defines the maximum size of each of the one or more area clusters 106. In an example, the maximum size of each of the one or more area clusters 106 is 7 kilometer. In another example, the maximum size of each of the one or more area clusters 106 is 5 kilometer. In yet another example, the maximum size of each of the one or more area clusters 106 may vary.

In an example, the commuting time refers to time taken to travel to the plurality of organizations from point A. In an example, the point A is a centroid point of the plurality of organizations. In another example, commuting distance refers to distance of the plurality of the organizations from a point B. In an example, point B is a centroid point of the plurality of organizations. In an example, commuting distance is calculated by calculating distance.

In an embodiment of the present disclosure, food accessibility includes information of nearby food shops, restaurants, grocery stores, and the like. In an embodiment of the present disclosure, transportation accessibility includes information about public transport facilities available in the geographical region. In an example, transportation accessibility includes cabs, taxis, bus, train, and the like. In general, population density is number of individuals per unit geographic area. In general, area is defined as space occupied by a flat shape or surface of an object.

The cluster identification system 110 analyzes the first set of data, the second set of data, and the set of rules in real-time using one or more hardware-run algorithms. In an embodiment of the present disclosure, the one or more hardware-run algorithms includes one or more machine learning algorithms. In another embodiment of the present disclosure, the one or more hardware-run algorithms include one or more artificial intelligence algorithms. In yet another embodiment of the present disclosure, the one or more hardware-run algorithms include one or more neural network models. In yet another embodiment of the present disclosure, the one or more hardware-run algorithms include one or more deep learning algorithms.

In general, machine learning is an application of artificial intelligence that provides a system with the ability to learn and improve automatically from experience without being explicitly programmed. In addition, machine learning focuses on development of computer programs that can access data and learn from data by itself. Further, machine learning system may be trained using one of three methods. The three methods of training of the machine learning system include supervised learning, unsupervised learning, and reinforcement learning. In an example, the machine learning algorithms in supervised learning includes Linear regression for regression problems, Logistic regression, Decision tree, Naïve bayes' classification, Support vector machines for classification problems, Random forest for classification and regression problems and the like. In another example, the machine learning algorithms in unsupervised learning include K-means clustering algorithm, Principal component analysis, Gaussian mixture models, Independent component analysis and the like. In yet another example, the machine learning algorithms in reinforcement learning includes q-learning algorithm, markov decision process, partially observable markov decision process and the like. In an example, the neural networks include but may not be limited to feedforward neural networks, recurrent neural networks, single layer neural networks, multilayer neural networks, fixed neural networks, adaptive neural networks, static neural networks and dynamic neural networks.

The cluster identification system 110 performs analysis of the first set of data, the second set of data, and the set of rules to identify the one or more area clusters 106 in the geographical area. The cluster identification system 110 identifies the one or more area clusters 106 in the geographical region based on the analysis of the first set of data and the second set of data with facilitation of the set of rules in real-time. In an embodiment of the present disclosure, the set of rules are pre-defined by the administrator 102. In another embodiment of the present disclosure, the set of rules are dynamic and set by the cluster identification system 110.

The set of rules enable dynamic identification of the one or more area clusters 106 in the geographical region based on the plurality of parameters. In an embodiment of the present disclosure, the plurality of parameters has a pre-defined value. In an example, a parameter of the plurality of parameters for the identification of the one or more area clusters 106 is that commuting distance should be less than 25 kilometer. In another example, another parameter of the plurality of parameter for the identification of the one or more area clusters 106 is that commuting time is less than 15 minutes. The pre-defined value is provided by the administrator 102. The commuting distance and commuting time are calculated with facilitation of calculation of centroid of each of the plurality of organization of the plurality of organizations.

The cluster identification system 110 displays the one or more area clusters 106 on the communication device 104 associated with the administrator 102 in real-time. The one or more area clusters 106 displayed by the cluster identification system 110 provide the cost efficient probable accommodation facilities. The cluster identification system 110 creates a cluster plot for each of the one or more area clusters 106 of the geographical region based on the plurality of parameters.

In an embodiment of the present disclosure, the one or more area clusters 106 are the clusters that include maximum number of the plurality of organizations. In another embodiment of the present disclosure, the one or more area clusters 106 are the clusters that include minimum number of the plurality of competitors. In yet another embodiment of the present disclosure, the one or more area clusters 106 are the clusters that include combination of the maximum number of plurality of organizations and minimum number of the plurality of competitors. In yet another embodiment of the present disclosure, the one or more area clusters 106 are the probable clusters where the administrator 102 should lease or rent the accommodation facilities for maximizing profit. In an embodiment of the present disclosure, the cluster identification system 110 identifies the one or more area clusters 106 to perform demand prediction of the accommodation facilities in each of the one or more area clusters 106.

The cluster plot is characterized in one or more forms. The one or more forms include bar graph, histogram, pictogram, pie graph, line graph, and, cartesian graph. The cluster plot is downloadable in one or more formats. The one or more formats include but may not be limited to chart, joint photographic experts group, portable network graphics, portable document format, scalable vector graphics, and comma-separated values.

In an embodiment of the present disclosure, the cluster identification system 110 identifies the one or more area clusters 106 in one or more geometrical shapes. In an embodiment of the present disclosure, the one or more geometrical shapes include at least one of triangle, square, rectangle, hexagon, octagon, polygon, and the like. In an embodiment of the present disclosure, the each cluster of the one or more area clusters 106 is circular in shape. In another embodiment of the present disclosure, each cluster of the one or more area clusters 106 is rectangular in shape. In yet another embodiment of the present disclosure, each cluster of the one or more area clusters 106 is triangular in shape. In yet another embodiment of the present disclosure, each cluster of the one or more area clusters 106 is of any possible geometrical shape. In an embodiment of the present disclosure, each cluster of the one or more area clusters 106 is similar in shape. In another embodiment of the present disclosure, each cluster of the one or more area clusters 106 is different in shape.

The cluster identification system 110 performs re-clustering of the one or more identified area clusters in real-time. The cluster identification system 110 performs the re-clustering based on real-time change in the first set of data, the second set of data, or the set of rules. The re-clustering is dynamic and adaptive based on real-time change in the first set of data, the second set of data, or the set of rules. The cluster identification system 110 performs the re-clustering to update the one or more area clusters 106 in the geographical region.

In an example, the cluster identification system 110 identifies a cluster A of the one or more area clusters 106 in the geographical region based on the analysis of the first set of data, the second set of data, and the set of rules. In addition, the cluster identification system 110 receives information that a new organization B is going to be set up in nearby area of the already identified cluster A. Further, the cluster identification system 110 receives information of the new organization B in real-time. Furthermore, the cluster identification system 110 performs re-clustering and accordingly changes the already identified cluster A in real-time.

The interactive computing environment 100 includes the server 112. The cluster identification system 110 is associated with the server 112. In general, server is a computer program that provides service to another computer programs. In addition, server may provide various functionalities or services, such as sharing data or resources among multiple clients, performing computation for a client and the like. In an embodiment of the present disclosure, the server 112 is at least one of dedicated server, cloud server, network server, virtual private server and the like. However, the server 112 is not limited to above mentioned servers.

In addition, the server 112 includes the database 114. In general, database is a collection of information that is organized so that it can be easily accessed, managed and updated. In an embodiment of the present disclosure, the database 114 is at least one of at least hierarchical database, network database, relational database, object-oriented database and the like. The database 114 provides storage location to the first set of data, the second set of data, the set of rules, data associated with the cluster identification system 110, and the like. In an embodiment of the present disclosure, the database 114 provides storage location to all the data and information required by the cluster identification system 110. In an example, the database 114 is connected to the server 112. The server 112 stores data in the database 114. The server 112 interacts with the database 114 to retrieve the stored data.

In an embodiment of the present disclosure, the cluster identification system 110 stores the first set of data, the second set of data, and the set of rules in the database 114. The cluster identification system 110 performs storing in real-time. In an embodiment of the present disclosure, the cluster identification system 110 updates the first set of data, the second set of data, and the set of rules in the database 114 associated with the cluster identification system 110. The cluster identification system 110 performs updating in real-time.

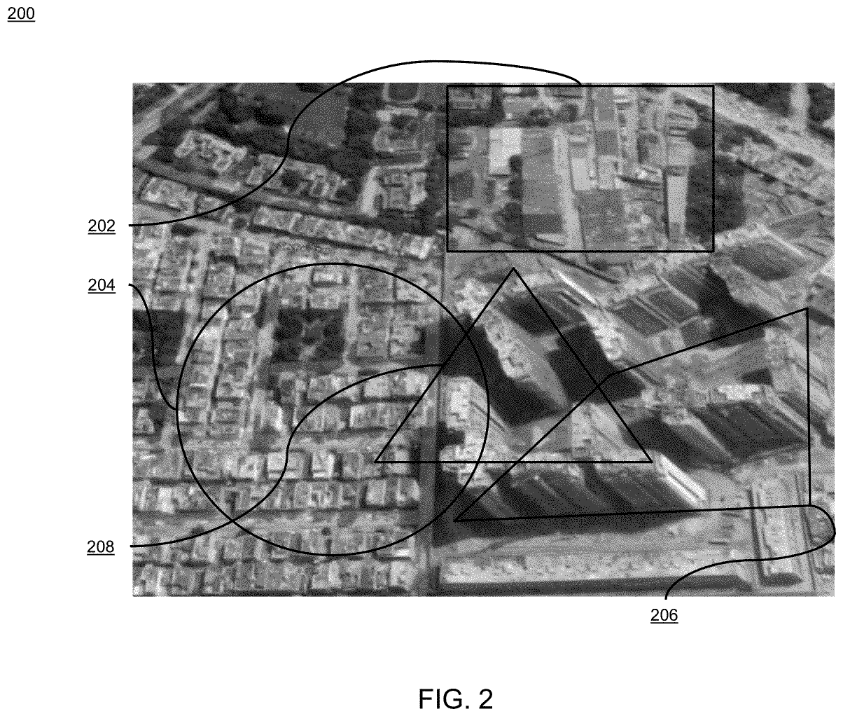

FIG. 2 illustrates an exemplary overview of the one or more area clusters 106 (of FIG. 1) in a geographical region 200, in accordance with various embodiments of the present disclosure. The geographical region 200 includes a first cluster 202, a second cluster 204, a third cluster 206 and a fourth cluster 208. The cluster identification system 110 receives the first set of data associated with the plurality of organizations. In addition, the cluster identification system 110 fetches the second set of data associated with the plurality of competitors. Further, the cluster identification system 110 obtains the set of rules associated with the plurality of parameters. Furthermore, the cluster identification system 110 analyzes the first set of data, the second set of data, and the set of rules to identify the one or more area clusters 106. The cluster identification system 110 identifies the one or more area clusters 106 using the one or more hardware-run algorithms. The one or more area clusters 106 include the first cluster 202, the second cluster 204, the third cluster 206, and the fourth cluster 208. The first cluster 202 is of square shape. The second cluster 204 is circular in shape. The third cluster 206 is of polygon shape. The fourth cluster 208 is triangular in shape.

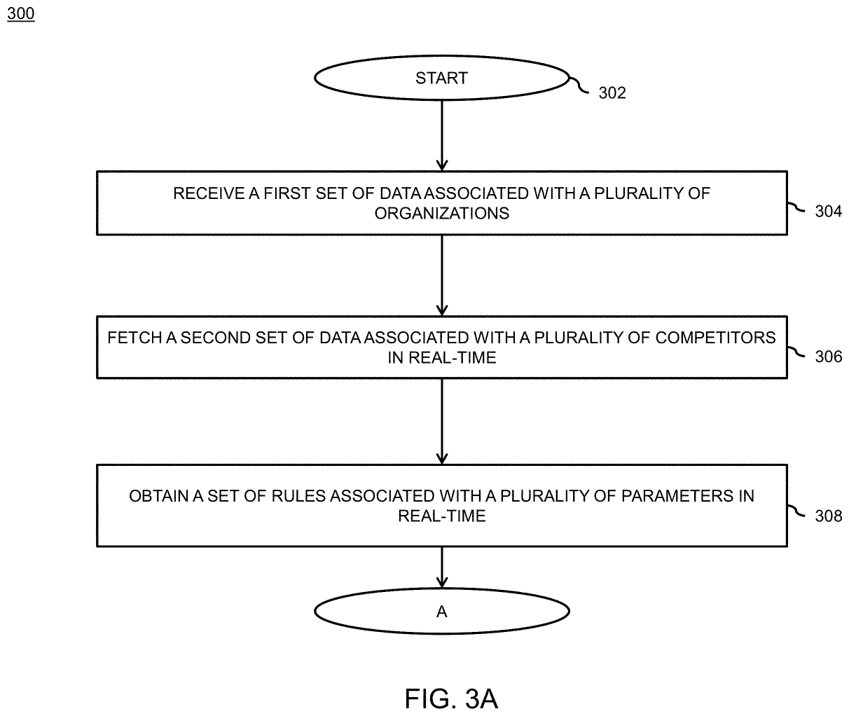

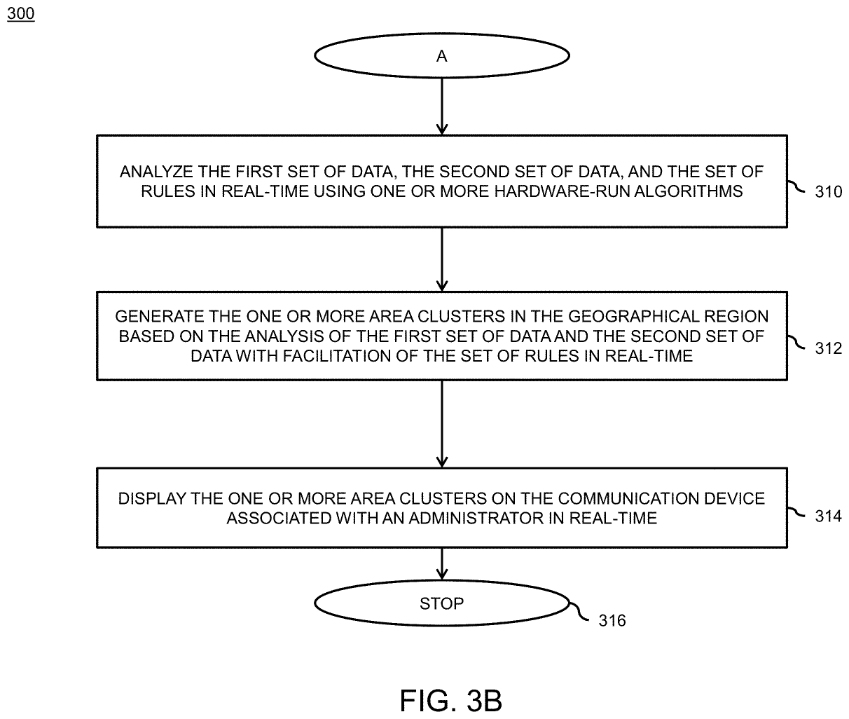

FIGS. 3A and 3B illustrate a flow chart 300 of method for identification of the one or more area clusters in a geographical region, in accordance with various embodiments of the present disclosure. It may be noted that to explain the process steps of flowchart 300, references will be made to the system elements of FIG. 1.

The flowchart 300 initiates at step 302. Following step 302, at step 304, the cluster identification system 110 receives a first set of data associated with a plurality of organizations. In addition, at step 306, the cluster identification system 110 fetches a second set of data associated with a plurality of competitors in real-time.

Further, at step 308, the cluster identification system 110 obtains a set of rules associated with a plurality of parameters in real-time. Furthermore, at step 310, the cluster identification system 110 analyzes the first set of data, the second set of data, and the set of rules in real-time using one or more hardware-run algorithms.

Moreover, at step 312, the cluster identification system 110 identifies the one or more area clusters 106 in the geographical region based on the analysis of the first set of data and the second set of data with facilitation of the set of rules in real-time.

Also, at step 314, the cluster identification system 110 displays the one or more area clusters 106 on the communication device 104 associated with the administrator 102 in real-time. The flowchart 300 terminates at step 316.

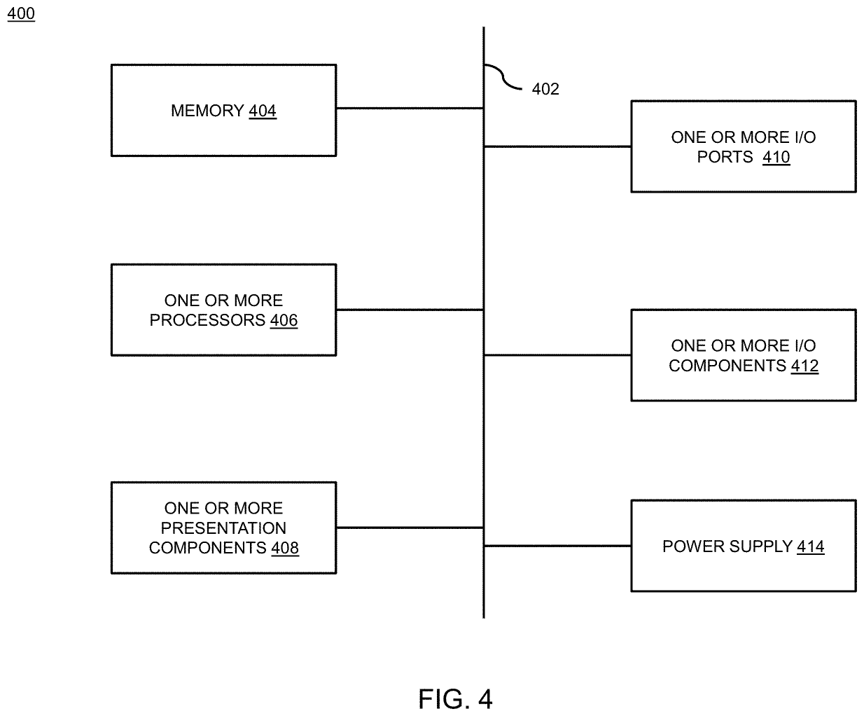

FIG. 4 illustrates a block diagram of a communication device 400, in accordance with various embodiments of the present disclosure. The communication device 400 represents internal hardware components of the communication device 104. The communication device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary communication device 400 that can be used in connection with one or more embodiments of the present invention. The distinction is not made between such categories as “workstation,” “server,” “laptop,” “hand-held device,” etc., as all are contemplated within the scope of FIG. 4 and reference to “communication device.”

The communication device 400 typically includes a variety of computer-readable media. The computer-readable media can be any available media that can be accessed by the communication device 400 and includes both volatile and nonvolatile media, removable and non-removable media. By way of example, and not limitation, the computer-readable media may comprise computer readable storage media and communication media. The computer readable storage media includes volatile and nonvolatile, removable and non-removable media implemented in any method or technology for storage of information such as computer-readable instructions, data structures, program modules or other data.

The computer-readable storage media with memory 404 includes, but is not limited to, non-transitory computer readable media that stores program code and/or data for longer periods of time such as secondary or persistent long term storage, like RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the communication device 400. The computer-readable storage media associated with the memory 404 and/or other computer-readable media described herein can be considered computer readable storage media for example, or a tangible storage device. The communication media typically embodies computer-readable instructions, data structures, program modules or other data in a modulated data signal such as a carrier wave or other transport mechanism and in such a includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The communication device 400 includes one or more processors that read data from various entities such as the memory 404 or I/O components 412. The one or more presentation components 408 present data indications to a user or other device. Exemplary presentation components include a display device, speaker, printing component, vibrating component, etc. The one or more I/O ports 410 allow the communication device 400 to be logically coupled to other devices including the one or more I/O components 412, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for identifying one or more area clusters in a geographical region for providing cost efficient probable accommodation facilities in each of the one or more area clusters, the computer-implemented method comprising:
receiving, at a cluster identification system with a processor, a first set of data associated with a plurality of organizations, wherein the first set of data is received in real-time, wherein each of the plurality of organizations is situated in the geographical region, wherein the first set of data is received from a plurality of data sources, wherein the plurality of data sources comprising at least one of an offline data source or an online data source;
fetching, at the cluster identification system with the processor, a second set of data associated with a plurality of competitors in real-time, wherein the plurality of competitors are entities that provide the accommodation facilities, wherein the second set of data is fetched from the plurality of data sources;
obtaining, at the cluster identification system with the processor, a set of rules associated with a plurality of parameters in real-time, wherein the plurality of parameters is associated with the geographical region, wherein the plurality of parameters comprising demand data of the plurality of organizations, real-time road conditions, real-time traffic conditions, commuting distance, commuting time, maximum size of each cluster of the one or more area clusters, food accessibility, transportation accessibility, population density of the geographical region, covered area of the geographical region, wherein the set of rules associated with the plurality of parameters is obtained from a communication device;
analyzing, at the cluster identification system with the processor, the first set of data, the second set of data, and the set of rules in real-time using one or more hardware-run algorithms, wherein the analysis of the first set of data, the second set of data, and the set of rules is performed for identifying the one or more area clusters in the geographical area;
identifying, at the cluster identification system with the processor, the one or more area clusters in the geographical region based on the analysis of the first set of data and the second set of data with facilitation of the set of rules in real-time; and
displaying, at the cluster identification system with the processor, the one or more area clusters on the communication device associated with an administrator in real-time, wherein each cluster of the one or more area clusters is visual representation of a region marked in the geographical region, wherein the displayed one or more area clusters provide the cost efficient probable accommodation facilities.

2. The computer-implemented method as recited in claim 1, wherein the first set of data comprising name of the plurality of organizations, contact numbers of the plurality of organizations, electronic mail addresses of the plurality of organizations, demographic information of employees working in the plurality of organizations, home town of employees working in the plurality of organizations, regional cuisine of employees working in the plurality of organizations, professional information of employees working in the plurality of organizations, accommodation requirement of the employees working in the plurality of organizations, positional coordinates of the plurality of organizations, demographic information of the plurality of organizations, and population density of the plurality of organizations.

3. The computer-implemented method as recited in claim 1, wherein the second set of data comprising demographic information of the plurality of competitors, number of the accommodation facilities provided by each of the plurality of competitors, population density of each accommodation facility of each of the plurality of competitors, operating cost of each accommodation facility of each of the plurality of competitors, capital expenditure of each accommodation facility of each of the plurality of competitors, accommodation price of each accommodation facility of each of the plurality of competitors, number of rooms in each accommodation facility of each of the plurality of competitors, tenant capacity of each accommodation facility of each of the plurality of competitors, geographical location of each accommodation facility of each of the plurality of competitors, and address of each accommodation facility of each of the plurality of competitors.

4. The computer-implemented method as recited in claim 1, wherein the plurality of data sources comprising third party databases, accommodation industry databases, real-estate databases, database containing information of the plurality of organizations, database containing information of the plurality of competitors, government official databases, geographical information databases, demographic survey data, market research data and publically available real estate data.

5. The computer-implemented method as recited in claim 1, wherein the plurality of organizations comprising corporations, government organizations, non-government organizations, cooperative organizations, and educational institutions.

6. The computer-implemented method as recited in claim 1, wherein the set of rules enables dynamic identification of the one or more area clusters in the geographical region based on the plurality of parameters, wherein the commuting distance and the commuting time are calculated with facilitation of calculation of centroid of each of the plurality of organizations.

7. The computer-implemented method as recited in claim 1, wherein the accommodation facilities comprising apartments, paying guest accommodations, hostels, dormitories, hotels, guest houses, homestays, and living quarters.

8. The computer-implemented method as recited in claim 1, further comprising performing, at the cluster identification system with the processor, re-clustering of the one or more identified area clusters in real-time, wherein the re-clustering is dynamic and adaptive based on real-time change in the first set of data, the second set of data, or the set of rules, wherein the re-clustering is performed for updating the one or more area clusters in the geographical region.

9. The computer-implemented method as recited in claim 1, further comprising creating, at the cluster identification system with the processor, a cluster plot for each of the one or more area clusters of the geographical region based on the plurality of parameters, the cluster plot is characterized in one or more forms, wherein the one or more forms comprising bar graph, histogram, pictogram, pie graph, line graph, and, cartesian graph, wherein the cluster plot is downloadable in one or more formats, wherein the one or more formats comprising chart, joint photographic experts group, portable network graphics, portable document format, scalable vector graphics, and comma-separated values.

10. A computer system comprising:
one or more processors; and
a memory coupled to the one or more processors, the memory for storing instructions which, when executed by the one or more processors, cause the one or more processors to perform a method for providing cost efficient probable accommodation facilities in each of the one or more area clusters, the method comprising:
receiving, at a cluster identification system, a first set of data associated with a plurality of organizations, wherein the first set of data is received in real-time, wherein each of the plurality of organizations is situated in the geographical region, wherein the first set of data is received from a plurality of data sources, wherein the plurality of data sources comprising at least one of an offline data source or an online data source;
fetching, at the cluster identification system, a second set of data associated with a plurality of competitors in real-time, wherein the plurality of competitors are entities that provide the accommodation facilities, wherein the second set of data is fetched from the plurality of data sources;
obtaining, at the cluster identification system, a set of rules associated with a plurality of parameters in real-time, wherein the plurality of parameters is associated with the geographical region, wherein the plurality of parameters comprising demand data of the plurality of organizations, real-time road conditions, real-time traffic conditions, commuting distance, commuting time, maximum size of each cluster of the one or more area clusters, food accessibility, transportation accessibility, population density of the geographical region, covered area of the geographical region, wherein the set of rules associated with the plurality of parameters is obtained from a communication device;
analyzing, at the cluster identification system, the first set of data, the second set of data, and the set of rules in real-time using one or more hardware-run algorithms, wherein the analysis of the first set of data, the second set of data, and the set of rules is performed for identifying the one or more area clusters in the geographical area;
identifying, at the cluster identification system, the one or more area clusters in the geographical region based on the analysis of the first set of data and the second set of data with facilitation of the set of rules in real-time; and
displaying, at the cluster identification system, the one or more area clusters on the communication device associated with an administrator in real-time, wherein each cluster of the one or more area clusters is visual representation of a region marked in the geographical region, wherein the displayed one or more area clusters provide the cost efficient probable accommodation facilities.

11. The computer system as recited in claim 10, wherein the first set of data comprising name of the plurality of organizations, contact numbers of the plurality of organizations, electronic mail addresses of the plurality of organizations, demographic information of employees working in the plurality of organizations, home town of employees working in the plurality of organizations, regional cuisine of employees working in the plurality of organizations, professional information of employees working in the plurality of organizations, accommodation requirement of the employees working in the plurality of organizations, positional coordinates of the plurality of organizations, demographic information of the plurality of organizations, and population density of the plurality of organizations.

12. The computer system as recited in claim 10, wherein the second set of data comprising demographic information of the plurality of competitors, number of the accommodation facilities provided by each of the plurality of competitors, population density of each accommodation facility of each of the plurality of competitors, operating cost of each accommodation facility of each of the plurality of competitors, capital expenditure of each accommodation facility of each of the plurality of competitors, accommodation price of each accommodation facility of each of the plurality of competitors, number of rooms in each accommodation facility of each of the plurality of competitors, tenant capacity of each accommodation facility of each of the plurality of competitors, geographical location of each accommodation facility of each of the plurality of competitors, and address of each accommodation facility of each of the plurality of competitors.

13. The computer system as recited in claim 10, wherein the plurality of data sources comprising third party databases, accommodation industry databases, real-estate databases, database containing information of the plurality of organizations, database containing information of the plurality of competitors, government official databases, geographical information databases, demographic survey data, market research data and publically available real estate data.

14. The computer system as recited in claim 10, wherein the plurality of organizations comprising corporations, government organizations, non-government organizations, cooperative organizations, and educational institutions.

15. The computer system as recited in claim 10, wherein the set of rules enables dynamic identification of the one or more area clusters in the geographical region based on the plurality of parameters, wherein the commuting distance and the commuting time are calculated with facilitation of calculation of centroid of each of the plurality of organizations.

16. The computer system as recited in claim 10, wherein the accommodation facilities comprising apartments, paying guest accommodations, hostels, dormitories, hotels, guest houses, homestays, and living quarters.

17. The computer system as recited in claim 10, further comprising performing, at the cluster identification system, re-clustering of the one or more identified area clusters in real-time, wherein the re-clustering is dynamic and adaptive based on real-time change in the first set of data, the second set of data, or the set of rules, wherein the re-clustering is performed for updating the one or more area clusters in the geographical region.

18. The computer system as recited in claim 10, further comprising creating, at the cluster identification system, a cluster plot for each of the one or more area clusters of the geographical region based on the plurality of parameters, the cluster plot is characterized in one or more forms, wherein the one or more forms comprising bar graph, histogram, pictogram, pie graph, line graph, and, cartesian graph, wherein the cluster plot is downloadable in one or more formats, wherein the one or more formats comprising chart, joint photographic experts group, portable network graphics, portable document format, scalable vector graphics, and comma-separated values.

19. A non-transitory computer-readable storage medium encoding computer executable instructions that, when executed by at least one processor, performs a method for providing cost efficient probable accommodation facilities in each of the one or more area clusters, the method comprising:
receiving, at a computing device, a first set of data associated with a plurality of organizations, wherein the first set of data is received in real-time, wherein each of the plurality of organizations is situated in the geographical region, wherein the first set of data is received from a plurality of data sources, wherein the plurality of data sources comprising at least one of an offline data source or an online data source;
fetching, at the computing device, a second set of data associated with a plurality of competitors in real-time, wherein the plurality of competitors are entities that provide the accommodation facilities, wherein the second set of data is fetched from the plurality of data sources;
obtaining, at the computing device, a set of rules associated with a plurality of parameters in real-time, wherein the plurality of parameters is associated with the geographical region, wherein the plurality of parameters comprising demand data of the plurality of organizations, real-time road conditions, real-time traffic conditions, commuting distance, commuting time, maximum size of each cluster of the one or more area clusters, food accessibility, transportation accessibility, population density of the geographical region, covered area of the geographical region, wherein the set of rules associated with the plurality of parameters is obtained from a communication device;
analyzing, at the computing device, the first set of data, the second set of data, and the set of rules in real-time using one or more hardware-run algorithms, wherein the analysis of the first set of data, the second set of data, and the set of rules is performed for identifying the one or more area clusters in the geographical area;
identifying, at the computing device, the one or more area clusters in the geographical region based on the analysis of the first set of data and the second set of data with facilitation of the set of rules in real-time; and
displaying, at the computing device, the one or more area clusters on the communication device associated with an administrator in real-time, wherein each cluster of the one or more area clusters is visual representation of a region marked in the geographical region, wherein the displayed one or more area clusters provide the cost efficient probable accommodation facilities.

20. The non-transitory computer-readable storage medium as recited in claim 19, wherein the first set of data comprising name of the plurality of organizations, contact numbers of the plurality of organizations, electronic mail addresses of the plurality of organizations, demographic information of employees working in the plurality of organizations, home town of employees working in the plurality of organizations, regional cuisine of employees working in the plurality of organizations, professional information of employees working in the plurality of organizations, accommodation requirement of the employees working in the plurality of organizations, positional coordinates of the plurality of organizations, demographic information of the plurality of organizations, and population density of the plurality of organizations.
